(19) United States
(12) Patent Application Publication
(10) Pub. No.: US 2002/0188459 A1
(43) Pub. Date: Dec. 12, 2002

(54) Resource conservation method

(76) Inventor: Stewart E. Erickson, Hudson, WI (US)

Correspondence Address: NAWROCKI, ROONEY & SIVERTSON, P.A., Suite 401, Broadway Place East, 3433 Broadway Street N.E., Minneapolis, MN, 55413, US

(21) Appl. No.: 10/047,821

(22) Filed: Jan. 15, 2002

Related U.S. Application Data
(60) Provisional application No. 60/253,554, filed on Nov. 28, 2000.

(51) Int. Cl. G06F 17/60

(52) U.S. Cl. 705/1; 705/35; 705/40

(57) ABSTRACT

A resource conservation method, including commodity market exchanges in furtherance thereof, is provided. Carbon dioxide is acquired from at least one carbon dioxide source for recycling the carbon dioxide. Valuable consideration is received for the acquisition of the carbon dioxide, with carbon dioxide provided, for valuable consideration, from a supply of the acquired carbon dioxide to growing plants for adsorption thereby in furtherance of photosynthesis. Water generally consumed by the growing plants is reduced and thus conserved, whereby financial incentives motivate carbon dioxide recycling and water conservation, thereby bringing arid land into productive use.

This is a regular application filed under 35 U.S.C. §111(a) claiming priority under 35 U.S.C. §119(e) (1), of provisional application Serial No. 60/253,554 having a filing date of Nov. 28, 2000, filed under 35 U.S.C. §111(b).

### TECHNICAL FIELD

The present invention generally relates to methods of resource conservation and commodity exchange methods related thereto, more particularly, it relates to brokerage methods and commodity market exchanges in furtherance of climate control and water conservation which thereby promote economic and land use efficiency.

### BACKGROUND OF THE INVENTION

With globalization gaining momentum and disposable income rising, industrial growth and the resulting effects upon our environment are expanding and deepening to unprecedented levels. The supply of resources such as energy; to produce durable goods, intermediaries, etc., water; to sustain agricultural operations, and land; to generally support the expanding population, is not unbounded.

Carbon Dioxide Emissions

Carbon dioxide from combustion of fossil fuels and from various industrial chemical processes, like the manufacturing of cement, coupled with deforestation, is increasing the earth's atmospheric carbon dioxide level. Atmospheric carbon dioxide traps heat by absorbing infrared energy, thereby preventing such energy from leaving the atmosphere. The capture of such heat at the earth's surface is commonly known as the “green house effect.” Scientific experts predict global temperatures will increase 2 to 7 degrees Fahrenheit by the year 2100 due to increasing greenhouse gases. It is suggested that global warming this century will significantly melt polar ice packs, raising sea levels 17 cm to 1 meter, thus flooding coastal regions around the globe.

In the United States, carbon dioxide emissions are caused largely by the combustion of coal, natural gas, and petroleum. A fraction (less than 2 percent) comes from other sources, including landfills and the manufacture of cement. Total estimated emissions increased by 3.5 percent (51.3 million metric tons) annually from 1995 to the present, so that currently about 1,631 million metric tons of carbon is produced each year. Compared to 1990 emissions levels, the increase is about 325 million metric tons or almost 25 percent.

The Energy Information Administration (EIA) energy statistics partition total energy consumption into four end-use sectors: industrial, transportation, residential, and commercial. For all sectors except transportation, a substantial portion of the energy used is consumed as electricity. In the future most of the growth in energy consumption is expected to be in the transportation sector, with increasing reliance upon the use of electricity. About two-thirds of the carbon dioxide emissions in the residential and commercial sectors are derived from electricity.

Although end users create the demand for electricity, electricity producers (primarily electric utilities) make decisions about how to meet that demand, based on fuel prices and capacity availability. In 1996 consumption of electric power increased by 2.4 percent, but utility carbon emissions increased by about 4.7 percent because coal-fired generation met a disproportionately large share of the increased demand for electricity so that by 1996 the total amount of carbon dioxide produced by electric utilities totaled 516.8 million tons per year, or approximately ⅓ of 1996 total emissions in the United States. Estimated carbon emissions for electric utilities for 1999 was estimated at 540 million tons. While technology has enabled the energy intensity of products and processes to decrease over the last 50 years, the increased efficiency has been outpaced by increased demand driven by economic expansion, population growth, and changing consumer preferences. In the aggregate, voluntary efforts have not ended overall growth in U.S. emissions. Indeed, U.S. emissions grew approximately 12 percent over the past decade. The lesson here is clear: voluntary programs can make a contribution but will not, on their own, be enough.

The Kyoto Protocol to the United Nations Framework Convention on Climate Change (UNFCCC), also known as the third session of the conference of the parties, or COP3, was negotiated in Kyoto in December 1997. Under the Protocol, which has been signed by the United States and 100 other countries, but yet to be ratified by the United States, the parties agreed to assigned amounts of “aggregate anthropogenic carbon dioxide equivalent emissions of greenhouse gases” over the period 2008 to 2012 (Protocol, Art. 3). Pursuant to Article 1, each party is challenged to promote sustainable development in achieving its quantified emission limitation. Policies and measures in furtherance thereof include: enhancement of energy efficiency in relevant sectors of the national economy; protection and enhancement of sinks and reservoirs of greenhouse gases and promotion of sustainable forest management practices, afforestation and reforestation; promotion of sustainable forms of agriculture in light of climate change considerations; research, promotion, development and increase use of, new and renewable forms of energy, of carbon dioxide sequestration technologies and of advanced innovative environmentally sound technologies; progressive reduction or phasing out of market imperfections, fiscal incentives, tax and duty exemptions and subsidies of all greenhouse gas emitting sectors that run counter to the objective of the convention and applications of market instruments, to name but a few (see generally, Protocol Art. 1(1) (a) (i)-(viii)).

The objective of the Kyoto Protocol is to impose binding greenhouse gas emissions targets for the world's industrial economies and the former communist economies of Europe (i.e., “Annex I Countries”) to be achieved by the period 2008 through 2012. By directly binding emissions, policy makers presumably believe that they could achieve the goals of the UNFCCC through political commitment. As explicit targets can be negotiated and easily monitored, this was perceived to be the easiest course to follow. Given that fixed targets for emissions by Annex I Countries have been agreed, although not yet ratified in key countries, the main issues currently being debated are how to minimize costs of the Kyoto Protocol and how to bring developing countries into the agreement.

The issues of cost minimization and developing country participation are clearly recognized in the Kyoto Protocol. Costs in part are addressed through provisions for international trading of emissions allowances among the countries that accept binding targets. Furthermore, the Protocol provides for a clean development mechanism (CDM), under which agents from industrial countries can earn emission credits for certified reductions from investments in “clean” development projects in developing countries that have not taken on binding targets. The Protocol states that “(t)he net changes in greenhouse gas (i.e., carbon dioxide (CO2), methane (CH4), nitrous oxide (N2O), hydroflourocarbons (HFCs), perflourocarbons(PFCs) and sulfur hexaflouride (SF6)) emissions by sources and removals by sinks resulting from direct human induced land use change and forestry activities, limited to afforestation, reforestation and deforestation since 1990.. shall be used to meet the commitments under this article . . . ” (Protocol Art. 3(3)). Many term definitions (e.g., “afforestation,” “reforestation,” and “deforestation”) are still being negotiated in international fora.

Under the Protocol, industrial nations must find ways to cut heat trapping emissions from burning fossils fuels that are believed to cause global warming by an average of 5.2% below 1990 levels in/during the period 2008 to 2012. (See Boston Globe, Sep. 3, 2000, p. A17). Under the Clinton Administration, the United States committed to reduce such emissions by 7%, amounting to a reduction to 1.5 billion tons. Due to stronger than expected U.S. economic growth and increased fuel usage, the official estimated U.S. emissions are about 2.05 billion metric tons of carbon by 2020, an increase of about 1.4% from 1999, and 600 million tons above the Kyoto target. (Report #DOE/EIA-0383 2001). U.S. officials estimate the target reduction, in terms of what is actually happening, is about a 30% reduction as opposed to a 7% reduction. (See Boston Globe). It is estimated that the United States could be credited with a reduction of about 300 million tons of carbon from carbon sinks, about half of the overall reduction called for under the Kyoto Protocol. As a matter of fact, as recently as August 2000, the United States has filed proposals with the UN's Environmental Office arguing that carbon absorbing forests and farmland, so called carbon sinks, should give the United States substantial credits under the Protocol to reduce emissions and other gases thought to be warming the planet. The State Department estimates that 38 other countries are due to file proposals that will be discussed at negotiations during the fall of 2000.

Water

Water demand is increasing throughout the world. In opening remarks given to the delegates of the 10th Annual Stockholm Water Symposium, water scarcity was identified as the most “underestimated emerging issue today”. (Lester Brown, President Worldwatch Institute, United States Water News Online, September 2000). Aquifer depletion and drained rivers are of paramount concern. Rivers such as the Colorado, Nile and Ganges are cited as among those that often run dry before they reach the sea, and it is estimated that 70% of water world wide is used for irrigation.

Regarding the mounting water deficits in the United States, the Department of Water Resources notes the following; “Southern California, with its relentless growth, is growing desperate for more water. Las Vegas, Reno, Denver, Boulder, Phoenix, San Jose, San Diego and lesser known cities such as Fresno, Calif., Westwendover, Nev. and St. George, Utah face similar predicaments of less daunting magnitude. By 2020, when California's population is expected to reach 50 million, drought year shortages could reach 4.7 million acre feet, more than twice the consumption of the 12 million people in Los Angeles today.” (Department of Water Resources Bulletins, 160/93 and 160/97). It is greatly acknowledged that metropolitan water demands are going to have to be met by diverting agricultural waters.

A less visible trend is that “over pumping” is depleting ground water aquifers faster than natural recharge at the global rate of 160 billion tons of water per year. Within several important U.S. crop producing regions, rapid ground water depletion is occurring. Both the cental valley of California and the Ogllala Aquifer, which underlies eight of the great plains states, have drastically falling water tables. Driven by falling water tables, increased pumping costs, and historically low crop prices, many farmers who depend on the Ogllala have already abandoned irrigated agriculture. The total Ogllala irrigated acreage in CO, KS, NE, NM, OK and TX has fallen from 5.2 million hectares to 4.2 million hectares and is predicted to fall to 3.1 million hectares by 2020. California is over drafting groundwater at a rate of 1.6 billion cubic meters a year, equal to 15% of the state's annual net groundwater use. Two thirds of this depletion occurs in the central valley, which supplies about half of the nation's fruits and vegetables. This situation is not limited to the United States, but is a global problem that is becoming increasingly acute in India, China, and the Middle East; “If over pumping stopped, world grain production would fall by at least 160 million tons, enough to feed 480 million of the world's 6 billion people” and the population is expected to grow 8.9 billion by 2050, another 2.8 billion people in just 50 years. The amount of water produced by the hydrological cycle is essentially the same today as it was in 1950, and is likely to be the same in 2050. It is with this picture in mind that the Wall Street Journal commented as follows, “The market's lure flows from powerful logic. As the population of the west swells—California alone is expected to be home to 40 million people by 2010, up from about 33.5 million now—the gap between water supply and water demand will only widen. If drought grips the west, companies with water to sell “have the potential to be the next Internet stocks”.”

Fertigation

Fertilizing the air circulating around plant's foliage with carbon dioxide is referred to as “fertigation”. Carbon is an essential plant nutrient that plants obtain from carbon dioxide in the air. The process whereby carbon dioxide is utilized by plants is known as photosynthesis.

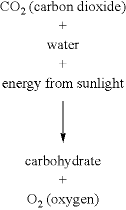

During this fundamental chemical process, plants capture carbon dioxide molecules and, using energy from visible light, build carbohydrates. Carbon dioxide from the atmosphere diffuses into the plant stomata, pores in the outer layer of leaf cells, with the gas ultimately arriving at the chloroplasts (i.e., organelles) in which photosynthesis takes place.

The entrance of the carbon dioxide molecules into plants' stomata entails a costly loss of water molecules out of the plants' leaves. For every molecule of carbon dioxide that enters the stomata, between 100 and 400 molecules of water are lost. See Plant Physiology, Salsbury & Ross, page 63. When exposed to elevated carbon dioxide gradients, guard cells in plant leaves relax and close forming a smaller aperture, thus impeding water molecules from escaping through the normally expanded aperture. In a carbon dioxide rich atmosphere, a higher concentration gradient would exist between the exterior and the interior of the leaves, and equivalent amounts of carbon dioxide would diffuse through stomatal openings, even as the stomatal apertures were kept smaller. In most plant species, reduced stomatal openings curtail water loss, so the plants require less water to grow the same size or bigger. The net result is that various crops may use from 20 percent up to 50 percent less water when exposed to elevated levels of carbon dioxide. Furthermore, it is known that smaller stomatal openings could improve the health of certain plants by limiting the entrance of air pollutants, such as sulfur dioxide, thereby reducing injury to those plants.

Beyond promoting water conservation, a carbon dioxide rich environment allows some plants to waste less energy during photosynthesis and offer disproportionately improved yields. Injection of carbon dioxide gas inside greenhouses to stimulate plant production was commercialized 40 years ago and is commonly practiced today. Air, on the average, contains slightly more than 0.03 percent (367 parts per million (ppm)) carbon dioxide. Commercial greenhouse operators know that plant responses increase as carbon dioxide levels increase above atmospheric level, with continued growth response up to 2,000 ppm in some crops. Most crops offer maximum yield between 1,000 to 1,500 ppm carbon dioxide, a level which is not considered harmful to humans. Levels above 5,000 ppm can be harmful to humans, and the maximum level tolerated in United States Navy submarines is 5,000 ppm. Plants' upper toxicity threshold is a bit lower, around 4,550 ppm carbon dioxide.

All forest tree species and many major crops, including: rice, wheat, potatoes, tomatoes, lettuce, and beans, respond well to fertigation. Certain species will grow better than others, but on average, grain production increases 34% in high carbon dioxide conditions, trees notably offer 40% yield increase, and tomatoes can have up to a 48% yield increase. Greenhouse operators have determined good economics for carbon dioxide injection, even when considering paying for a supply of carbon dioxide (i.e., treating acquisition thereof as an expense rather than a credit).

To promote plant growth, conserve valuable irrigation water, and recycle/sequester industrial carbon dioxide emissions, it has been proposed to commercially broaden the greenhouse carbon dioxide gas “fertigation” practice into regional outdoor applications. Patented carbon dioxide gas transmission and distribution systems, as those disclosed in U.S. Pat. Nos. 5,409,508, 5,682,709, and 6,108,967, each of which is incorporated herein by reference, in their entirety, will deliver carbon dioxide gas to orchards, vineyards, agricultural row crops (e.g., vegetables), forestry plantations, and potential field crops like grains. Such systems transmit carbon dioxide gas from a variety of industrial and geological sources using transmission pipes, transport vehicles, subterranean voids and/or porous geological zones. Grids of tubes, will evenly disseminate the gaseous carbon dioxide fertilizer make it available in the air circulating throughout the foliage of targeted fields of crops and trees.

Fertigation also significantly reduces plants' water consumption. Because crops require much less water when exposed to carbon dioxide enrichment, carbon dioxide gas actually acts as a substitute for irrigation water. This inverse carbon dioxide/water relation is of particular importance to irrigation dependent agricultural regions like southern California, that consume incredible volumes of water for irrigation, yet have unmet increasingly metropolitan water demands.

Irrigation

As a practical matter, irrigation involves many players, each of whom behaves according to a set of rules and incentives. These players include farmers, irrigation districts, water user organizations, state or provincial water agencies, and private voluntary organizations, engineering firms, politicians, and taxpayers.

The rules, by and large, have been stacked against efficiency, equity, and environmental sustainability. Large government subsidies, an estimated $33 billion a year worldwide, keep water prices artificially low, discouraging farmers from investing in efficiency improvements. Inflexible laws and regulations have discouraged the marketing of water, leading to inefficient water allocation and use. The absence of rules to regulate groundwater use has led to the over pumping and depletion of aquifers, and has worsened inequities between the rich, who can afford to deepen their wells, and the poor, who cannot. The failure to place a value on freshwater ecosystem services-including maintenance of water quality, flood control, and the provision of fish and wildlife habitat has left far less water in natural systems than is socially optimal.

Correcting these policy failings is no easy task. In most cases it requires bucking entrenched and powerful interests. However, if society is to redesign irrigated agriculture to make it both productive and sustainable in an era of water scarcity, there is little choice but to take up the challenge.

The key is to custom-design strategies to fit the farming culture, climate, hydrology, crop choices, water use patterns, environmental considerations, and other characteristics of each particular area. Successful strategies almost always involve a synergistic mix of measures. Farmers will not invest in efficient technologies, for example, if they have no incentive to do so, and, these technologies will only improve water productivity if accompanied by good management practices.

For example, when combined with soil moisture monitoring of other ways of assessing crops' water needs accurately, drip irrigation can achieve efficiencies as high as 95 percent, compared with 50-70 percent for more conventional flood or furrow systems. Studies have consistently shown drip irrigation to cut water use by 30-70 percent and to increase crop yields by 20-90 percent-often leading to a doubling of water productivity. Over the last two decades, the area of land irrigated by drip and other micro-irrigation methods has risen 50 fold, to an estimated 2.8 million hectares. Nonetheless, this total represents just over 1 percent of all irrigated land worldwide. A few recent developments suggest, however, that drip's share could expand markedly in the years ahead.

As unproductive land and increased production per acre through use of irrigation, and fertilizer fail to keep up with world population growth, demands for food and timber will increase significantly. Further, with increased regulation governing logging timber will more and more be grown in intensely managed tree plantations. The agricultural and silvicultural industries are searching for new solutions to increase profitability per acre. Further, environmentalist are urging these industries to implement new cost effective solutions to reduce erosion and fertilizer runoff. Taking advantage of low cost, dual use technology for delivering gas can be an economically viable means of doing this.

Under the Kyoto Protocol, roughly 600 million tons per year of reduced carbon emissions would be required by 2010 for the United States. Some of these savings will come through reduced gasoline consumption in transportation, but a large portion of the savings is likely to come from efficiencies at the nations electric utilities. The ability of electric utilities to sell emissions (i.e., emissions allowance trading (EAT)) to services which can sequester the carbon is likely to become a major market going forward, despite resistance from the European members of Kyoto.

Emission allowance trading is a straightforward concept that is already operational on a national scale in the area of sulfur dioxide emissions. Congress placed an overall restriction on power plant sulfur dioxide emissions nationwide, effectively allowing power plants to comply by either (1) investing in cleaner fuels or pollution control technologies, or (2) purchasing extra emissions rights from another power plant that made extraordinary emission cuts. Buying excess rights from a more efficient power plant allows the older and less efficient plant to meet its obligations at lower cost to consumers. As noted in the Wall Street Journal Oct. 26, 1999, under the caption “U.S. landfill concern, Ontario Utility agreed swap gas emission rights: officials from both sides said Ontario Powered Generation, Inc. has bought from Zahren Alternative Power Corp. the rights to emit 2.5 million tons of carbon dioxide—roughly the equivalent release by 550,000 cars in one year . . . such rights are effectively off set pollution futures . . . the deal was structured as a private exchange because it comes before a global treaty is in place for governments to formally recognize such international emission deals.” In short, trading emissions permits allows industry to meet emissions goals in a least cost way. This would represent the same trading platform for carbon dioxide.

Estimates of the value of carbon emissions allowances range from $15 per ton (Council of Economic Advisers) to $348 per ton (EIA). Based on early market signals in some test trading environments market values of between $30 and $50 per ton of carbon would tend to be more in line with future market expectations. Without a market to trade carbon emissions, the lower prices (and the lower mitigation cost to society) would not be possible. The agricultural sector would provide the most reasonable source for this demand, and in particular forestry and crop land offer the most promise.

It is believed that carbon dioxide gas transmission and distribution technology can be commercially implemented around the globe. It is also apparent that industrialists that emit carbon dioxide as a bi-product of chemical processes, primarily combustion and cement manufacturing, are actively looking for ways to sequester/recycle carbon dioxide, using crops and trees as carbon sinks. Carbon dioxide fertigation will allow industrialists to achieve their desired carbon dioxide emission reduction/recycling goals, while increasing crop yields, making nonproductive arid lands more productive, and liberating irrigation water for sale to thirsty metropolitan districts.

### SUMMARY OF THE INVENTION

Resource conservation methods, including commodity market exchanges in furtherance thereof, are provided. In one embodiment of the subject invention carbon dioxide is acquired from at least one carbon dioxide source for recycling the carbon dioxide. Valuable consideration is received for the acquisition of the carbon dioxide, with carbon dioxide provided, for valuable consideration, from a supply of the acquired carbon dioxide to growing plants for adsorption thereby in furtherance of photosynthesis. Water generally consumed by the growing plants is reduced and thus conserved, whereby financial incentives motivate carbon dioxide recycling and water conservation, thereby bringing arid land into productive use. The valuable consideration for providing carbon dioxide may be selected from the group consisting of money, credit (e.g., tax credit, emission credit, water credit etc.) or other assets (i.e., title thereto).

In an alternate embodiment of the invention, carbon credits are obtained for growing plants, with the carbon credits made available to carbon credit consumers as dictated by the market therefore. The carbon dioxide is sequestered for selective application to the growing plants, with the application of the carbon dioxide aiding the growth thereof. When such method is practiced using terrestrial plants, the terrestrial plants require less irrigation water, which may then be made available either directly or indirectly for valuable consideration.

In yet a further embodiment, financing for capital investment for fertigation is acquired in furtherance of recycling carbon dioxide. The financing may take many forms. For instance, the financing may be in the form of: a credit against enhanced yield projections vis-a-vis fertigation; a credit against projected water sales from conserved irrigation water vis-a-vis the fertigation of crops; a credit against projected tax credits from conserved irrigation water resulting from fertigation of crops; a credit against grant money for implementing a fertigation program; or, a credit against crop futures (i.e., notions of microclimate and price sensitivity arising therefrom), to name but a few.

More specific features and advantages obtained in view of those features will become apparent with reference to the drawing figures and DETAILED DESCRIPTION OF THE INVENTION.

### BRIEF DESCRIPTION OF THE DRAWINGS

FIG. 1 illustrates the general elements of a fertigation process, along with their interrelatedness to each other and with respect to an intermediary;

FIG. 2 depicts potential commodity market exchanges commensurate with/to the conservation method of the subject invention;

FIG. 3 depicts a range of commodities available to the intermediary resulting from the conservation method of the subject invention;

FIGS. 4A & 4B depict the benefits generally accruing to the fertigation partners subject to the brokerage arrangement consistent with the subject invention, more particularly, those associated with industrial and naturally occurring carbon dioxide sources respectively;

FIGS. 5A & 5B depict the benefits generally accruing to the fertigation partners subject to the brokerage arrangement consistent with the subject invention, more particularly, the fundamental exchange of carbon dioxide for conserved irrigation water, and the further contemplated exchanges of emission credits, including enhanced yield speculation, respectively; and,

FIG. 6 illustrates indicia borne at least indirectly by products marketed as being at least derived from plants grown with recycled carbon dioxide.

### DETAILED DESCRIPTION OF THE INVENTION

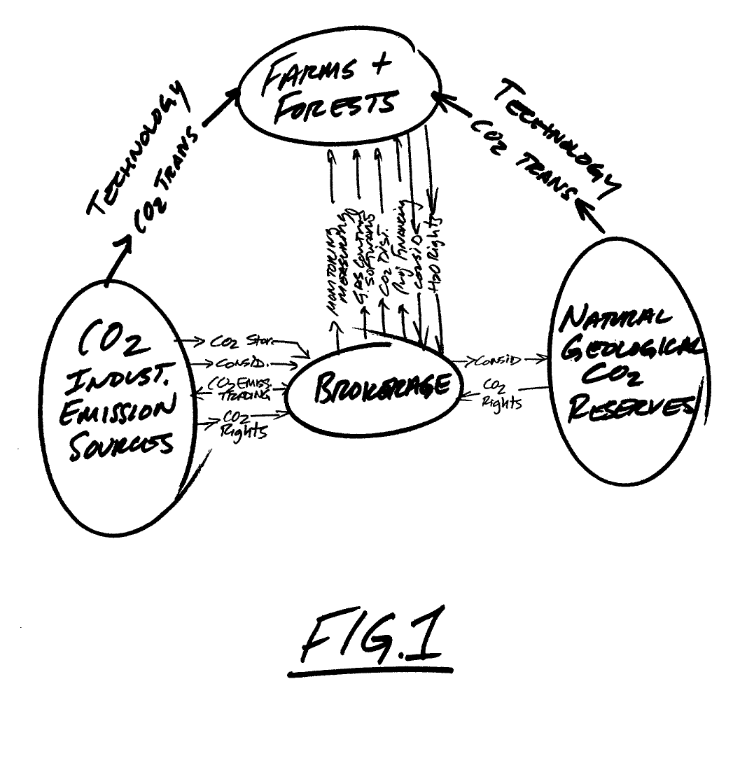

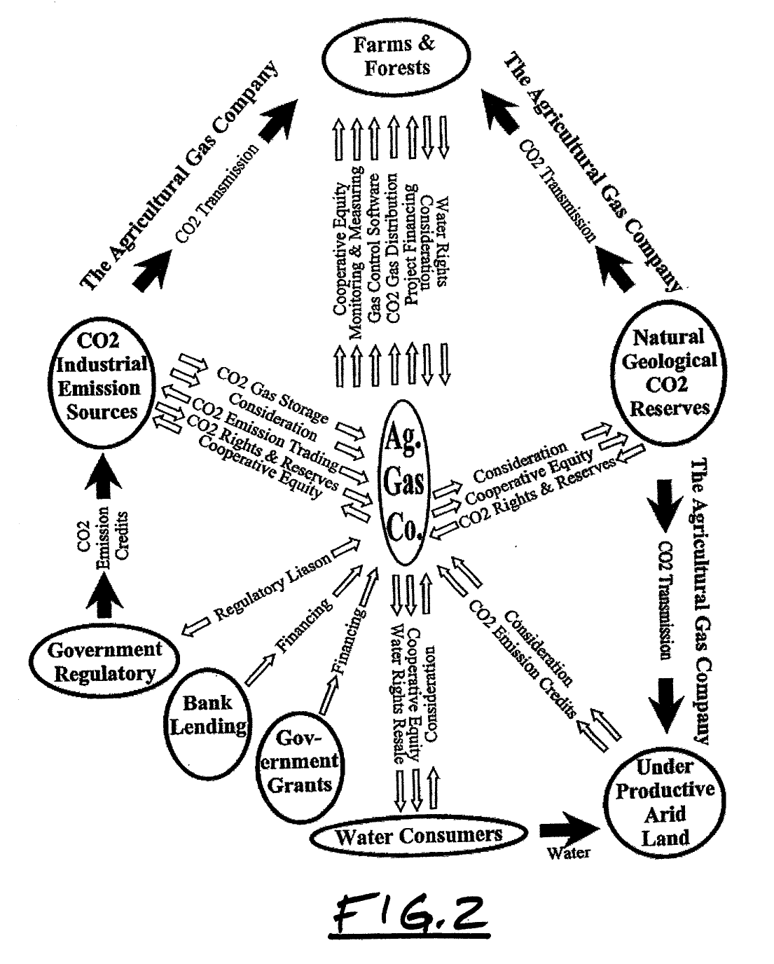

Elements, including the interrelationships therebetween, of the method of the subject invention are generally shown in the figures. Referring to FIG. 1, there is schematically shown in block form the general elements of a fertigation process (i.e., the fertigation arch), along with a representation of the interrelatedness of said elements. Carbon dioxide, whether it be naturally occurring or the bi-product of industrial operations, is supplied either directly or indirectly to growing crops (e.g., agriculture, aquaculture, silvaculture, etc.). As indicated in FIG. 1, the carbon dioxide sources are figuratively and literally linked to the crops by technology, as detailed the disclosures of U.S. Pat. Nos. 5,409,508, 5,682,709, and 6,108,967 (each of which is incorporated herein by reference in its entirety). A broker, or more specifically, a technology intermediary, effectively links the supply (i.e., the carbon dioxide source) with the demand (i.e., the growing crops) in ways not previously known nor practiced. The technology intermediary may provide consulting services in a broad sense, namely arranging and supporting commodity market exchanges among resource owners and resource users, along with providing technical support in the fields of agriculture, horticulture, silvaculture, and aquaculture, particularly as it relates to resource conservation.

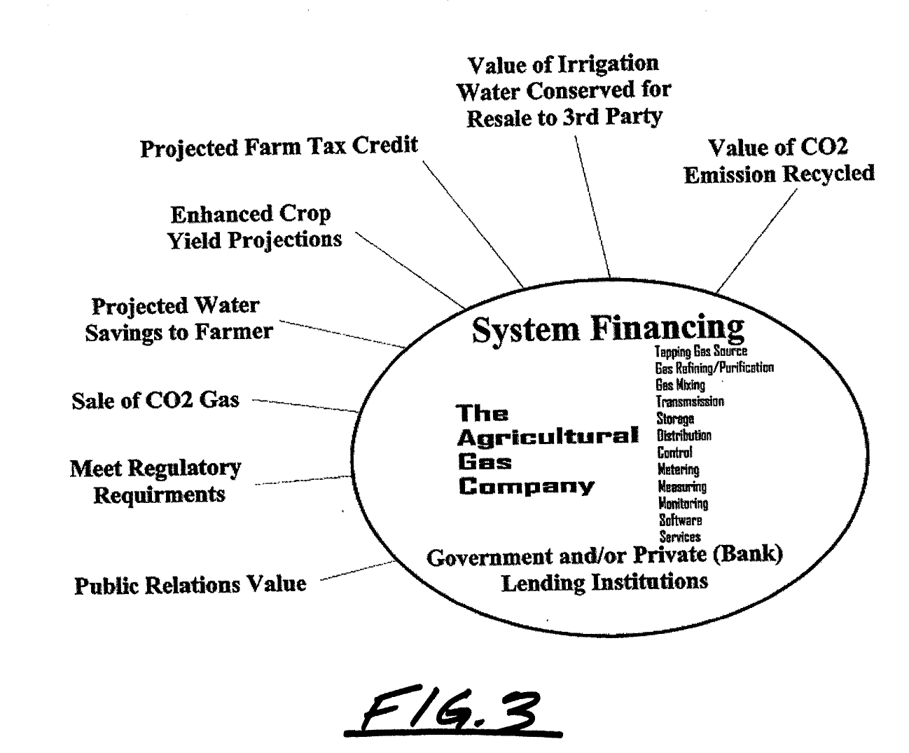

Referring now to FIG. 2, the technology intermediary is again shown linking the supply to the demand via technology (i.e., carbon dioxide storage and transmission), and further shows an expanded service role for the intermediary, namely a pivot point for, among other things, commodity market exchanges. As previously noted, the brokerage has up until this point provided technology, know-how, and technology consulting services to the suppliers and users of carbon dioxide in a fertigation context. In the contemplated expanded role, the brokerage, whether it be stylized as a joint venture, cooperative or other entity, directs, and at a minimum facilitates commodity market exchanges between the entities of FIG. 1, namely carbon dioxide suppliers and crop growers. Representative commodities are shown in the flow chart, and may include, but are not limited to: carbon dioxide emission credits; carbon dioxide rights and reserves (i.e., alienable assets); cooperative equity; project financing; water rights; tax credits; and, other forms of consideration (e.g., money, credit, assets, etc.). Further market players contemplated for exchanges of services/commodities include but are not limited to: “regulators” (e.g., governmental bodies such as state or federal agencies, country or city boards, water districts/commissions, etc.); financial institutions (e.g., banks, investors, public/private grants, etc.); water consumers, in a broad sense; and, those having an ownership interest (e.g., title, lease, etc.) in under-productive or arid land.

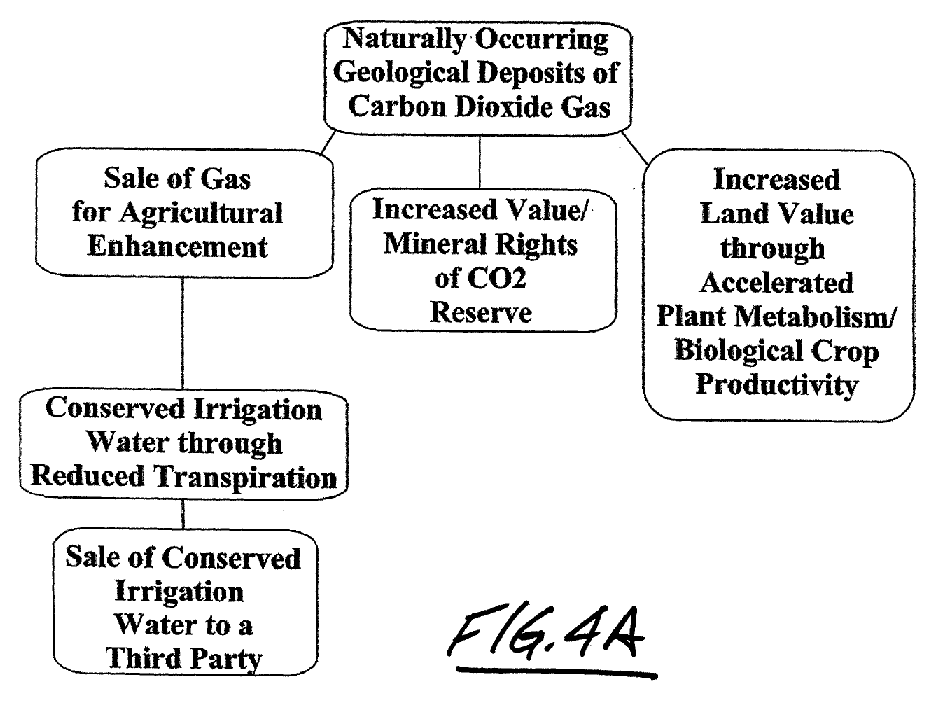

Referring now to FIG. 3, the brokerage contemplates activity in the “perimeter” commodities, namely: the value of recycled carbon dioxide emissions; the value of conserved irrigation water resulting from fertigation; projected tax credits associated with crop management motivated either directly or indirectly by fertigation; the value of enhanced crop yield, both projected and realized; the value of conserved irrigation water to the crop management entity; the value of the carbon dioxide gas as a consumable; the value of regulatory compliance; and the perceived public relations value of “green” business practices by the players or trading partners. The brokerage seeks to leverage these commodities on behalf of each of, or groups of, the several entities or organizations to secure capital for a variety of purposes, such as the deployment and implementation of fertigation systems and technology related thereto.

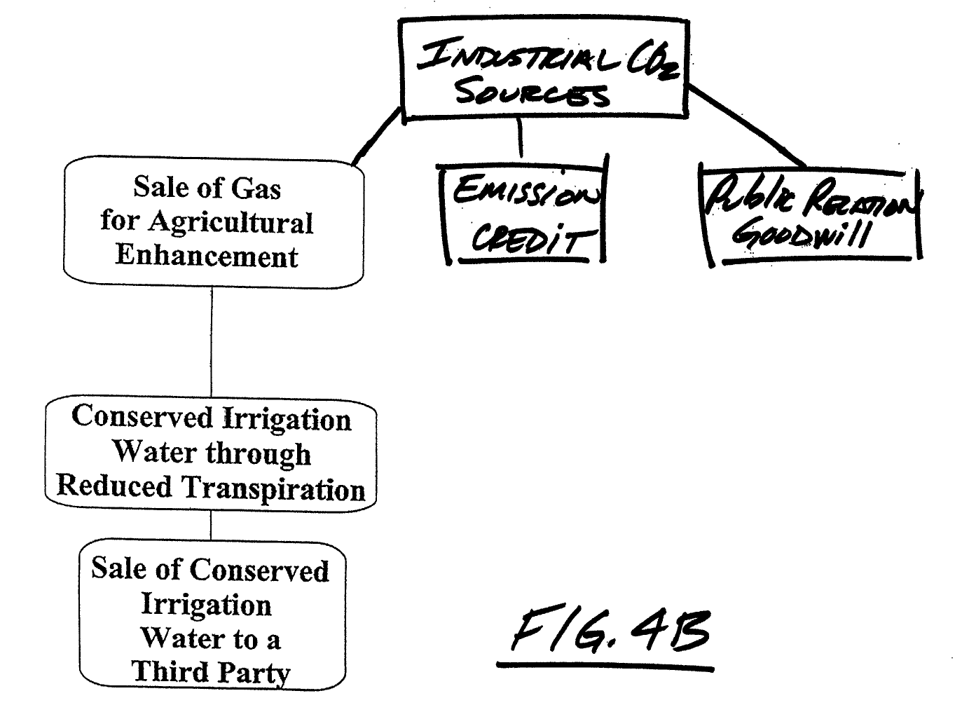

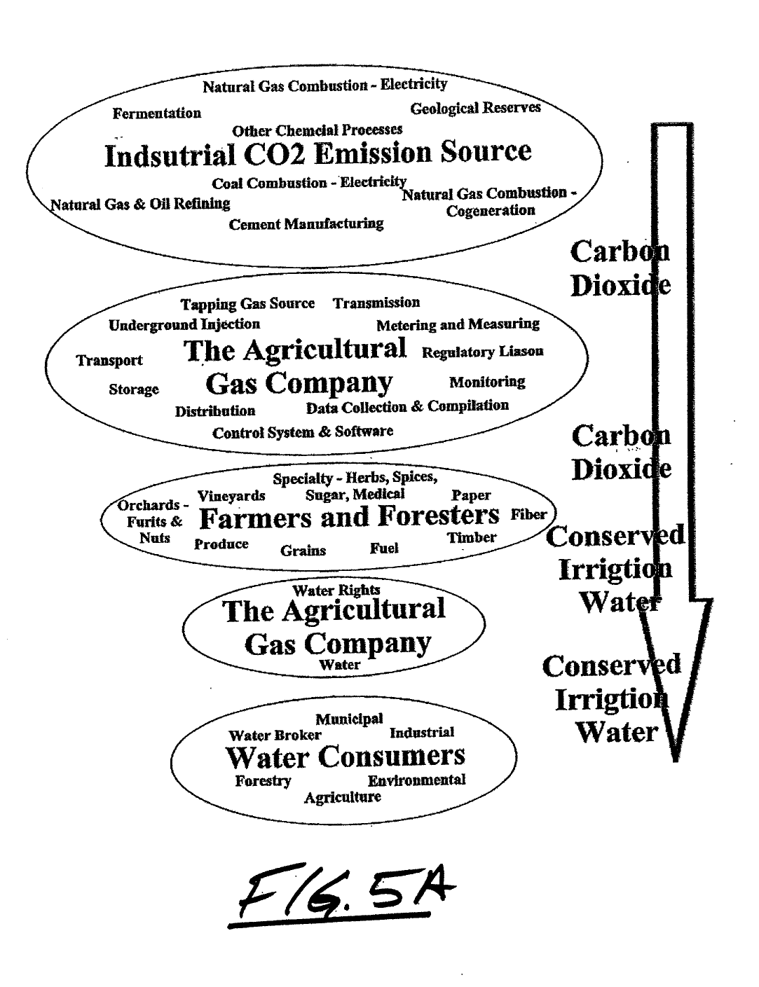

Referring now to FIGS. 4A-6, the benefits generally accruing to the fertigation partners subject to the brokerage arrangement are shown. For instance, FIG. 4A depicts a scenario wherein carbon dioxide is supplied, at least indirectly, from a naturally occurring state or condition. In this scenario carbon dioxide may be sold or traded as a commodity for agricultural enhancement or the like. The provision of carbon dioxide to growing plants for absorption in furtherance of photosynthesis thereby conserves irrigation water through reduced transpiration. The conserved irrigation water thus becomes a commodity exchangeable, for a variety of forms of consideration, to third parties. Furthermore, the “land” within which, or upon which, this carbon dioxide is found thereby obtains an increased value status vis-a-vis the carbon dioxide reserve being viewed as something analogous to a “mineral right”, as well as value accruing due to the accelerated plant metabolism and enhanced biological crop productivity produced thereby. FIG. 4B illustrates the benefits associated with industrial carbon dioxide fertigation sources. In lieu of increased property value under the scheme of FIG. 4A, further value is realized in this scenario vis-a-vis emission credits obtained by the diversion of carbon dioxide for agricultural enhancement or the like, and also by the public relations goodwill associated with “green” business practices.

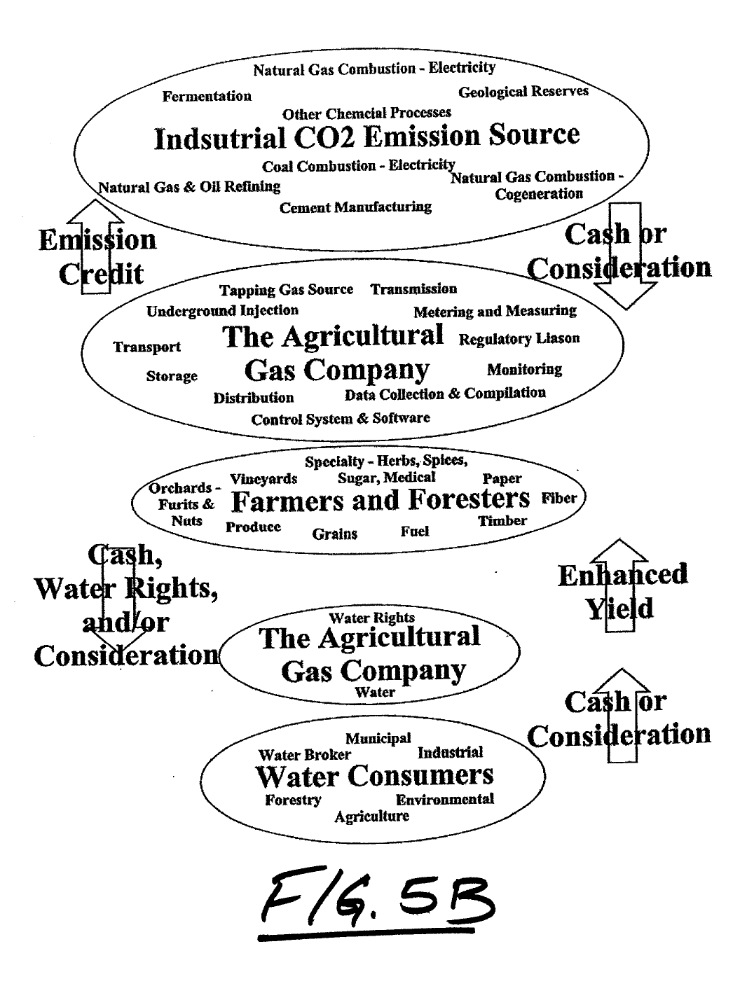

Referring now to FIGS. 5A and 5B, each further detail the nature of the trading partners, with FIG. 5A showing the fundamental exchange of carbon dioxide for conserved irrigation water, and FIG. 5B building thereupon, illustrating the potential leverage between trading partners, particularly showing the exchanges between the several entities, including but not limited to emission credit trading, enhanced yield speculation, etc. (see also the hub-and-spoke exchanges of FIG. 2).

The Business Model

The focus of the intermediary is consulting, primarily in the fields fertigation technology, more specifically, the areas of carbon dioxide distribution and transmission, carbon credit exchange and water rights trading. In the area of carbon dioxide emission trading, the brokerage will be responsible for finding utility companies that want to pay to have carbon dioxide sequestered. The gas irrigation systems and plots will be monitored to identify amounts of carbon dioxide recycled (i.e., quantified) and the brokerage will work with the utility for valuation, trading and documentation. As to water rights trading, the brokerage will identify and target “farmers” in high value regions of the country with senior “wet” water that can be sold or traded to metropolitan water districts. The brokerage will also be responsible for monitoring and quantifying the amount of water that is conserved by gas irrigation, and then subsequently sell, or otherwise transfer title to, this available volume of water to a metropolitan or industrial water customer.

Supply: Electric Utilities

Recent estimates indicate that the overall potential for carbon sequestration using United States cropland and forestry at 120-270 million metric tons of carbon per year. Thus, these markets could be used to contribute to a 30% reduction in carbon under Kyoto Protocol, while providing economic benefits to the agricultural industry as they sequester carbon. At an estimated trade price of $40 per ton paid by the electric utilities times the estimated demand for carbon in the agricultural sector of 120-270 million metric tons of carbon per year, the potential size of the supply side of the market is estimated at $4.8 to $10.8 billion.

Demand: Forestry

Forestry demand generally tracks with the retail housing and to a lesser extent paper sectors. Retail housing is projected to remain in the high range of 1.35 to 1.47 million units constructed nationally for the period from 2000 through 2005, and home remodeling/furnishings is in a current growth trend projected to continue rising at 5% annually over the same period. Next, consumer spending is projected to reach $4.59 trillion in 1999, up from $4.48 trillion in 1998, an increase of 2.45%. Thus, the demand for lumber products is likely to remain very positive at the present time

The majority of the forestry industry's activity occurs in the Pacific Northwest, which accounts for 59% of round wood production in the United States as of the most recent census 1990 (though the numbers of such mills in the Pacific Northwest have been declining since 1990). Sales of the smaller mills are not directly tracked, but follow closely with the overall logging and sawmill industry. Total revenues in the lumber industry have declined slightly for the past five years nationally, but remain at a high $74.8 billion for all roundwood products in 1999.

A primary factor currently affecting the lumber industry in addition to supply/demand factors include a sharp reduction of timber being made available for logging in the National Forests. Specifically, softwood (Spruce, Pine and Fir) production in the Pacific Northwest has declined from 9.8 billion board feet in 1989 to less than 7.5 billion board feet in 1993. A similar decline has occurred in the rocky mountain states. Thus, the regional decline in timber has resulted in a national increase in log prices, though much of this increase has occurred in the early 1990's. Currently there has been stabilization in log prices.

Increasing the productivity of existing forests by redirecting carbon dioxide to forestry biomass would provide a unique opportunity to an industry faced with decreasing availability of timberland. The application of elevated levels of carbon dioxide beneath the forested canopy can increase timber production by 40% according to recent studies. A 40% increase in supply by foresters would represent a potential market improvement of $30 billion on existing timberland, representing the demand side size of this market in the forestry area.

Demand: Farming & Farm Land

Productive capacity for farm crops in the United States is projected to rise due to increases in land use and productivity. These gains reflect the continued movement within the agricultural sector to larger more efficient farms. Planted acreage for major crops has risen about 20 million acres above averages in the early 1990s, with area gains drawn into production based on market incentives. Increased planting flexibility under the 1996 Farm Act also facilitated these acreage gains. Thus, by 1999, total arable land under tillage has reached approximately 1.3 billion acres in total. The ability to add future farm land to supplies however is not as likely in the near future (i.e., next ten years), as conversion of farmland to commercial and residential uses appears to be continuing unabated. Thus, future supply growth will likely occur entirely through productivity gains.

Domestic demand for most crops is projected to grow slightly faster than population in the years ahead. Notably stronger domestic growth for rice reflects a greater emphasis on dietary concerns and increasing numbers of Americans of Asian and Latin American origins. Gains in corn sweetener use and corn used for ethanol production also creates demand greater than a growing population base. Increases in domestic soybean crush reflects continued strong growth in poultry production and demand for soybean meal among both feed animals and direct human consumption. The one area anticipated to remain flat is in domestic wheat. Long-term trends in supply/demand balances for the major field crops imply tightening stocks-to-use ratios and strengthening nominal prices from 1999 to 2007. Thus, any technologies, which can increase productivity and therefore return on investment on existing arable land will be beneficial to a market with continued growing demand.

The total value of United States agricultural exports will also likely rise steadily from $57.3 billion in fiscal 1997 to nearly $85 billion by 2007 as the developing countries continue their strong rates of growth, which additionally leads to demand for greater quantities of agricultural grains. Thus, demand from outside the United States will continue strongly as well.

The national average market value of agricultural land has remained relatively steady at approximately $700 to $1,200 per acre through the 1990s with current strength as various sectors of agricultural commodities experience strengthening prices and new technologies enhance farmland productivity. The application of carbon dioxide to farm fields in the atmosphere or as organic carbon to the soils can have the effect of increasing productivity from 10% to 15%. Total agricultural production in the United States totals approximately $150 billion. Thus, a 10% to 15% improvement in productivity could enhance revenues by $15 billion to $22.5 billion annually. Similar to the area of forestry, the revenues paid to companies providing carbon delivery services would represent approximately 15% of the enhanced revenues of $15 to $22.5 billion, or a total market size of $2.25 to $3.4 billion to the carbon dioxide recycling industry sector, of which the subject is a part.

Demand: Conserved Irrigation Water

The cost of developing new water sources begins to demonstrate why acquisition of reasonably priced existing water assets for resale or lease has become such a promising investment opportunity: economists have noted that water has demonstrated strong price inelasticity, with some comparing a water bill to a cable television bill. (Scientific American, January 1992).

Beginning in the 1990s, the swelling population of the Southwestern United States has begun to exceed the capacity of the arid regions ability to supply water. The state where this is most true is in Southern California, which is served by two primary water sources: the Colorado River Basin and the Sacramento-San Joaquin Delta. The Sacramento-San Joaquin Delta is the primary water source for two-thirds of California's population. This delta draws 5.5 million-acre feet annually of fresh water south to the Central Valley farmland areas and to the Los Angeles area. The remaining one-third of California's population (all located on the south end of the state) relies upon an agreed allocation of water among the states serviced by the Colorado River Basin. California's share is 4.2 million-acre feet annually, though the state has been drawing in excess of that sum for the past decade (averaging 5.5 million-acre feet annually). This excess draw is currently under review and an enforced 4.2 million-acre foot allocation is likely. An acre-foot is equal to a one acre sized parcel with one foot of water or approximately 236,000 gallons of water. It is also equal to the water use of a typical family of five for one year.

All agricultural water users in California (i.e., private, state or federal projects) have some kind or quantum of water rights. Annual average applied irrigation water in California is over 30 million acre-feet. Water consumption within the Los Angeles area alone is currently estimated at 2 million-acre feet for urban/commercial consumption, or 20% of total water demand. The remaining water use, with estimates in excess of 10 million-acre feet annually, is utilized by irrigated agricultural land on a total of 4.2 million acres. The tightening supply has resulted in an eight-fold increase in the cost of water for agricultural uses over the past ten years, with the agricultural community responding by shifting their crops from lower cost grain/soy crops to the higher value agricultural crops such as vegetables, fruits and wine crops. The cost of water within California is currently at $4,000 per acre-foot. A typical agricultural crop in the region requires 2.25 to 3.0 acre-feet of water irrigation annually per acre of irrigated land. The demand for water within California is projected to continue to grow sharply, as population is estimated to increase from 32 million persons in 2000 to 47 million by 2020. It is anticipated that the one water using sector which will come under greatest pressure to give up their water rights will be in the area of agriculture.

Because many of the agricultural areas in California pre-date the rising urban populations and heightened water demand, these areas have retained significant water rights. Annual average applied irrigation water in California is estimated at over 30 million acre-feet, and it is these rights which could be sold for urban use. The value of agricultural water rights under current pricing is estimated at $90 billion (at $4,000 per acre-foot for actual consumed water). This price is anticipated to rise over the next ten years. Although it is noted that some of this water is being utilized for animal farming, which would not benefit from the subject method, in California the vast majority of water is being utilized for agricultural crops, which may be less true for some of the other western states such as Colorado.

The services anticipated to be offered by the brokerage and methods of the subject invention, in addition to increasing the productivity of existing agricultural plants and the like, does so using substantively less water. Therefore, for irrigated land areas, less water can be utilized to irrigate crops (saving costs on production) and the water saved could be consolidated and sold for urban uses. The redirection of carbon dioxide to irrigated land areas through the very same drip irrigation channels used for the water would provide a unique opportunity to an industry faced with decreasing availability of water throughout the arid West.

The application of elevated levels of carbon dioxide through the irrigation channels can reduce water use by an estimated 20% to 30% for typical irrigation crops according to recent studies. A 20% to 30% increased water savings would represent a potential market for the agricultural water rights saved within California alone of $18 billion to $27 billion.

The other western states which could experience irrigated water savings include the areas around Phoenix, Ariz. (with agricultural water use estimated at 1.5 million acre feet), and Nevada (at 2 million acre feet). Water savings in these areas could add to water rights savings of an estimated $2.8 billion to $4.2 billion (again estimating a $4,000 current market price per acre foot of water rights).

It is likewise noted that other applications within the arid Southwest could also include the numerous golf courses, where water savings could be quite measurable. The Phoenix area alone maintains nearly 70 golf courses within the metropolitan area which would contribute to a measurable water savings.

Fertigation Focus

While some crops may not react in as a pronounced manner to the application of carbon dioxide, many grain, tree, fruit, vegetable and algae crops will bear remarkable increase in yields. Frost prevention is another area of important opportunity as are existing drip irrigation systems particularly in high-density forestry plantations. Ginseng is grow under netting which could help reduce wind and act as a canopy to trap elevated gas levels also these may to tend to be high value crops so viability thereby increases. More particularly, the following representative list of target “crops” is provide for the sake of illustration, it is not meant to be limiting in any way: vineyards; raisins orchards plantations; rubber trees; apples; bananas; oil palms; peanuts; pistachios; almonds; avocados; peaches; pears; citrus; fiber; pines; poplars; eucalyptus; cotton; wheat; vegetables; soy beans; rice; algae; berries; and, tree nuts.

Point Sources

If areas sources of gas can be identified or established than transmission of the gas may prove less problematic as the gas only has to be brought to the surface at the distribution point or there about. Point sources will also require some transmission unless the source is immediately adjacent to the distribution fields. Regulatory issues with both transmission and distribution may exist.

Carbon dioxide can come from a plethora of sources varying greatly in purity. Sources can be manmade or naturally (i.e., geologically) occurring. Manmade sources may be stationary (e.g., a utility plant). or mobile (e.g., automobile), while geologic sources would most generally be fixed, and regional in nature. As carbon dioxide sources must be free of gaseous contaminates that would be harmful to humans, plants, and the environment, gas sources must be routinely calibrated and/or continuously monitored for purity.

If the carbon dioxide source is from natural gas combustion, the combustion fuel source must be pure from sulfur since any sulfur contained in it is converted to sulfur dioxide gas, which is injurious to plants. The sulfur content of natural gas or propane should not exceed 0.002 percent by weight. Furthermore, incomplete combustion will cause the formation of ethylene and carbon monoxide gases which are injurious to plants. The upper limit of ethylene for plants is 0.05 ppm. Manufactured gases and to a degree natural gas, can contain propylene and butylene, which are similarly injurious to plants. The threshold for propylene, above which plant injury occurs, is 10 ppm. Carbon monoxide is harmful to humans, with an upper average exposure limit of 50 ppm (American Conference of Government Industrial Hygienists 1986).

Area Sources

An area sources is an underground geologic structure containing voids filled with elevated levels of carbon dioxide which could cover hundreds of square miles. It could be as big as a gas cap placed over the depleted Ogallala Aquifer covering eight Great Plain states. This could be naturally occurring gas deposits or manmade through carbon dioxide injection into an abandoned mine, a depleted aquifer zone, and/or a porous geological zone any of which also could cover hundreds of square miles. The Bravo Dome is an area in northeast New Mexico that is a large naturally occurring geological deposit of carbon dioxide.

Markedly negative responses may occur if carbon dioxide levels are increase beyond maximum response concentrates. Not only have researchers noted yield responses vary from specie to specie, but can also offer markedly different responses for the same crop, from different growing regions. Plant toxicity thresholds are specie specific and can vary for a given specie from region to region.

The present and future increasing environmental demands are due to exploding world population, and evolving consumer buying habits for more commodities like dairy products, especially those of emerging under developed nations like India and China. Because opportunities to increase crop yields through use of irrigation, hybrid seeds and fertilizers have been greatly optimized in the United States, there is a need to further increase crop yields. Further, killing frost continue to wreak havoc on farmers' crops particularly fruits and vegetables grown extensively in the southern United States. The brokerage strategy outlined herein, and the methods of the subject invention are intended to fulfill a commercial need to increase crop yields, protect crops from damaging cold weather conditions, and generally conserve resources. Mine reclamation processes can also be readily enhanced using the technology allowing hundreds of thousands of acres of under-productive mined lands to be reinstated to high levels of productivity while reducing regional water pollution problems associated with mining.

The methods of the subject invention, particularly in the context of the business model contemplated, readily increase crop yields of existing fields, bring on valuable new aridable lands that are not currently in production, and transform deserted bodies of water into highly productive mediums. Further direct results of the methodologies of the subject invention include, among other things, tangible consumer benefits, namely, higher quality grown plants, and the well known benefits associated therewith (e.g., see the work of B. A. Kimball, U.S. Water Conservation Laboratory, more particularly, his series “Response of Vegetation to Carbon Dioxide,” 1986, number 039, 1887, number 049, and 1988, number 052). It is further hypothesized that there is a reduced uptake of air borne pollutants with application of carbon dioxide, such reduction yielding healthier fruits/vegetables for human consumption. Furthermore, in addition to the quality of the growing or grown plant, whether it be the “natural” product(s) thereof (e.g., fruits, vegetables, timber, etc.) or processed components thereof (e.g., wine from grapes, juice from fruit, paper from trees, etc.) providing the “value-added”, the subject methodologies contemplate marketing products at least derived (i.e., originating) from plants grown using recycled carbon dioxide as being produced using recycled carbon dioxide. An especially appealing tomato has appeal because it is an especially appealing tomato (i.e., is by definition differentiated), however, a specially produced and marketed especially appealing tomato may garner a premium in the market place.

As consumers, how we perceive products is critical. We are peppered with market surveys and opnion polls—“what do you like most about the new and improved widget from Acme, Inc. and why . . . . ” People are handsomely compensated for studying our buying habits in hopes of detecting trends and ultimately identifying the value added product element, more particularly, the essence of our buying criteria. As previously noted with respect to consumer choice, there exist matters pertaining to the inherent nature of the product (e.g., in the setting of the grocer check out and the query “paper or plastic,” a judgement might be rendered based upon strength, with plastic being thereby chosen), and those which are tangential, or otherwise a side bar, which nonetheless effect our decision making (e.g., the plastic bags are generally perceived as less environmentally friendly, therefore paper may be preferred).

The methodology of the subject invention contemplates, among other things, introducing consumables into the marketplace bearing indicia (e.g., a certification mark or the like) that they have been grown using carbon dioxide, more particularly recycled carbon dioxide. It is believed that a consumable (e.g., a bottle of wine) bearing such indicia (i.e., grapes grown using recycled carbon dioxide) would be preferentially selected by consumers, even at a premium price, as a product so identified would be valued as environmentally friendly, carbon dioxide being a greenhouse gas contributing to ozone depletion. As a matter of fact, a premium price may be based solely upon the origin of the wine, that is to say based upon the fact that recycled carbon dioxide contributed to grape growth, not global warming. On a more grand scale, fast food restauranteurs, for example, are believed to be motivated to purchase potatoes, for making french fries, so grown and marked, in furtherance of promoting their “green practices.” Furthermore, energy crops (e.g., corn/ethanol) may be identified as being grown using recycled carbon dioxide at the gas pump/dispenser. As is well known, and evidenced for example, by mutual funds directed to environmentally conscientious corporate citizenry, there exist a valuable market share for items produced in an environmentally friendly way, and companies practicing resource conservation and recycling in furtherance of their business objectives.

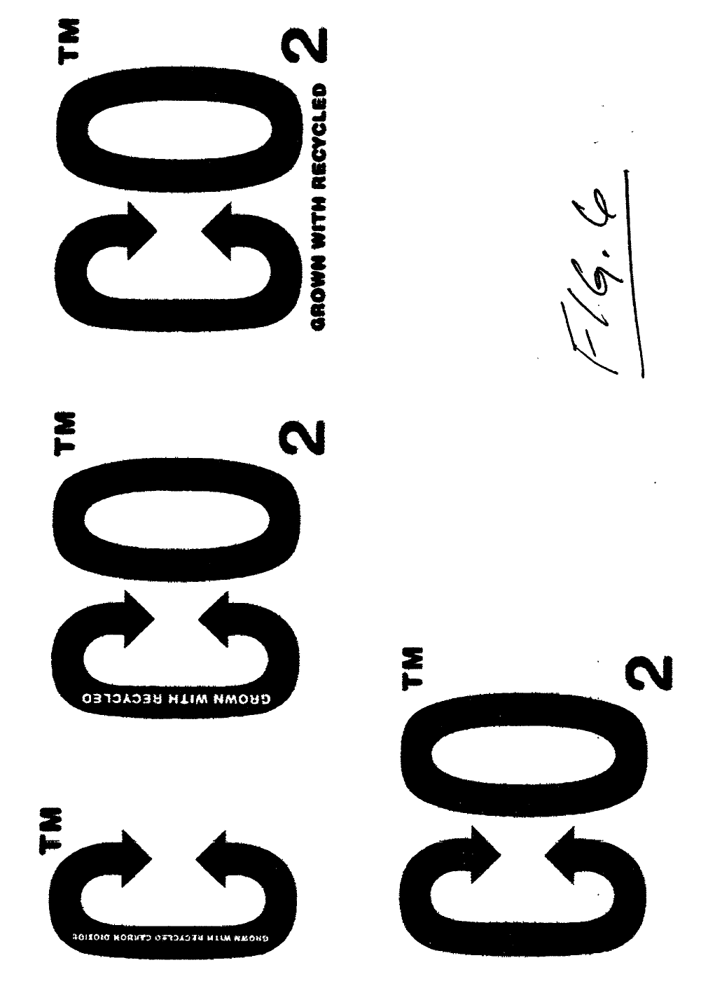

Preferably, items directly produced from plants grown using recycled carbon dioxide (e.g., fruit of a fruit tree, vegetables of vegetable plants, etc.) and items indirectly produced from plants grown using recycled carbon dioxide (e.g., paper from trees so grown, juice from the fruit of fruit tree so grown, etc.) would bear indicia in the market place. For instance, the indicia may be a graphic, illustration, symbol, word or words (see FIG. 6) borne by the item, as by a tag in the context of a produce stand. It may be stand alone, or incorporated with other product/source identifying of detailing information. The indicia may be, but need not be, registered as a trademark, collective mark or certification mark. Finally, the nature of the indicia, and its interrelationship with the product, is to be predicated upon the nature of the product, that is to say whether the product goes from the plant grown using recycled carbon dioxide (e.g., the tomato from the vine so grown), or for example whether the product is not insignificantly processed (e.g., wine from grapes so grown).

It will be understood that this disclosure, in many respects, is only illustrative. Changes may be made in details, particularly in matters of shape, size, material, and arrangement of parts without exceeding the scope of the invention. Accordingly, the scope of the invention is as defined in the language of the appended claims.

What is claimed is:

1. A resource conservation method comprising the steps of:
a. acquiring carbon dioxide from at least one carbon dioxide source for recycling said carbon dioxide; and,
b. providing for valuable consideration, carbon dioxide from a supply of said acquired carbon dioxide to growing plants for adsorption thereby in furtherance of photosynthesis, water consumed by said growing plants being thereby reduced and thusly conserved, whereby financial incentives motivate carbon dioxide recycling, water conservation, improved soil fertility, and productive use of arid land.

2. The resource conservation method of claim 1 further comprising the step of receiving valuable consideration for the acquisition of said carbon dioxide.

3. The resource conservation method of claim 2 wherein said valuable consideration for the acquisition of said carbon dioxide is selected from the group consisting of money, credit and assets.

4. The resource conservation method of claim 3 wherein said valuable consideration for providing carbon dioxide is selected from the group consisting of money, credit and assets.

5. The resource conservation method of claim 1 wherein said valuable consideration for providing carbon dioxide comprises receipt of money payment.

6. The resource conservation method of claim 5 further comprising the step of receiving valuable consideration for the acquisition of said carbon dioxide.

7. The resource conservation method of claim 6 wherein said valuable consideration for acquisition of said carbon dioxide comprises receipt of money payment.

8. The resource conservation method of claim 7 wherein said valuable consideration for providing carbon dioxide further comprises an ownership interest in conserved water.

9. The resource conservation method of claim 8 wherein said valuable consideration for acquisition of said carbon dioxide further comprises carbon credits.

10. The resource conservation method of claim 1 further comprising the step of providing valuable consideration for the acquisition of said carbon dioxide.

11. The resource conservation method of claim 10 wherein said valuable consideration for the acquisition of said carbon dioxide is selected from the group consisting of money, credit and assets.

12. The resource conservation method of claim 1 wherein the provision of said carbon dioxide from said supply of acquired carbon dioxide further includes transmitting said carbon dioxide from said supply to said growing plants.

13. The resource conservation method of claim 12 wherein said at least one carbon dioxide source comprises an industrial point source.

14. The resource conservation method of claim 12 wherein said at least one carbon dioxide source comprises a naturally occurring geological deposit.

15. The resource conservation method of claim 12 wherein said growing plants are growing out of doors.

16. The resource conservation method of claim 12 wherein the transmission of said carbon dioxide comprises a distribution system.

17. The resource conservation method of claim 16 wherein said distribution system comprises conduits.

18. The resource conservation method of claim 17 wherein said conduits are subterranean.

19. The resource conservation method of claim 17 wherein said conduits include pipes.

20. The resource conservation method of claim 19 wherein said pipes discharge carbon dioxide above the ground surface.

21. The resource conservation method of claim 19 wherein said pipes discharge carbon dioxide below the ground surface.

22. The resource conservation method of claim 19 wherein said pipes discharge carbon dioxide at the ground surface.

23. The resource conservation method of claim 12 wherein the transmission of said carbon dioxide comprises at least one aerial balloon.

24. The resource conservation method of claim 12 wherein the transmission of said carbon dioxide comprises a transport vehicle.

25. The resource conservation method of claim 24 wherein said transport vehicle includes a flexible container for retaining a volume of carbon dioxide for transmission.

26. The resource conservation method of claim 1 wherein said supply of said acquired carbon dioxide comprises an underground structure.

27. The resource conservation method of claim 26 wherein said underground structure includes a natural feature.

28. The resource conservation method of claim 27 wherein said natural feature comprises the soil matrix.

29. The resource conservation method of claim 26 wherein said underground structure includes a manmade feature.

30. The resource conservation method of claim 29 wherein said manmade feature comprises a mine shaft.

31. The resource conservation method of claim 12 wherein said supply of said acquired carbon dioxide comprises an above ground structure.

32. A method of commodity market exchange comprising the steps of:
a. obtaining carbon emission credits in exchange for growing plants;
b. making said carbon emission credits available to carbon emission credit consumers for valuable consideration;
c. acquiring carbon dioxide from at least one of said carbon emission credit consumers for recycling said carbon dioxide; and,
d. providing for valuable consideration, carbon dioxide from a supply of said acquired carbon dioxide for selective application to said growing plants for adsorption thereby so as to fortify said growing plants.

33. The method of claim 32 wherein said growing plants are aquatic.

34. The method of claim 32 wherein said growing plants are terrestrial.

35. The method of claim 34 wherein said terrestrial growing plants require less irrigation water to mature, thereby conserving water.

36. The method of claim 35 further including the step of making conserved water available either directly or indirectly to consumers for valuable consideration.

37. In a method of acquiring existing water assets for resale, the step comprising acquiring carbon dioxide emissions for fertigation so as to conserve irrigation water, said conserved irrigation water being thereby available directly or indirectly to water consumers as dictated by the market therefore for alternate uses.

38. In a method of recycling carbon dioxide, the step comprising acquiring financing for capital investment in fertigation.

39. The method of claim 38 wherein said financing comprises credit against enhanced yield projections from fertigation of growing plants.

40. The method of claim 38 wherein said financing comprises credit against projected water sales from conserved irrigation water resulting from fertigation of growing plants.

41. The method of claim 38 wherein said financing comprises credit against projected tax credits from conserved irrigation water resulting from fertigation of growing plants.

42. The method of claim 38 wherein said financing comprises credit against grant money for fertigation.

43. The method of claim 38 wherein said financing comprises credit against grant money for water conservation.

44. The method of claim 38 wherein said financing comprises credit against projected tax credit from water conservation resulting from fertigation of growing plants.

45. The method of claim 38 wherein said financing comprises credit against crop futures from fertigation of crops.
